(19) United States
(12) Patent Application Publication
(10) Pub. No.: US 2005/0163391 A1
(43) Pub. Date: Jul. 28, 2005

(54) Image correcting apparatus, and image correcting program storage medium

(75) Inventor: Hironobu Ishida, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/037,285

(22) Filed: Jan. 19, 2005

(30) Foreign Application Priority Data
Jan. 22, 2004 (JP) 2004-014086
Jan. 22, 2004 (JP) 2004-014095

(51) Int. Cl. H04N 9/73

(52) U.S. Cl. 382/254

(57) ABSTRACT

An image correcting apparatus comprises: an analyzing section that performs a predetermined image analysis for an image to determine a correction value defining an image correction to the image; a correction alteration section that alters the correction value determined by the analyzing section or a correction target in accordance with an alteration amount designated by an operation; an image correction section that applies an image correction to the image to obtain an image having a correction result associated with a correction value altered by the correction alteration section or the correction target; and a range set-up section that sets-up a range of an instruction allowable alteration amount to the correction alteration section.

### BACKGROUND OF THE INVENTION

1. Field of the Invention

The present invention relates to an image correcting apparatus for applying an image correction to an image, and an image correcting program storage medium storing an image conversion program.

2. Description of the Related Art

Hitherto, there is known a technology of an automatic correction in which image data representative of an image is used to perform an image analysis, and an image correction is applied to the image data in accordance with a result of the image analysis, and also there are known an image correction apparatus and an image correction program, which perform such an automatic correction. According to the automatic correction as mentioned above, generally, there are performed various types of image correction, such as density correction, white balance regulation (color temperature regulation), chroma saturation regulation, and sharpness conversion. However, the automatic correction is not complete. Sometimes, there happen inconveniences such as a shortage of correction, an excess of correction, and an error of correcting direction.

In some case, those inconveniences are caused by for example, a difference in machine type, or a matter of taste of a user. In this case, there is proposed a technology to avoid the inconveniences by means of customizing an automatic correction through taking into consideration a difference in machine type, or a matter of taste of a user (cf. for example, Japanese Patent Document “TokuKai. 2002-16874”).

However, even if the technology disclosed in Japanese Patent Document “TokuKai. 2002-16874” is used to customize the automatic correction, there is a possibility of occurrence of the inconveniences in correction of individual images, owing to inaccuracy of the analysis due to the principle limits of the image analysis, since the automatic correction supposes the image analysis using the image data. For this reason, the image correction apparatus and the image correction program need a function of altering the correction through an instruction of adequate correction by the manual operation, when such inconveniences occur.

While the conventional image correction apparatus and image correction program are also provided with the function of altering the correction through an instruction of adequate correction by the manual operation, the conventional image correction apparatus and the like are troublesome in operation of the correcting instruction. Further, according to the conventional image correction apparatus and the like, the higher degree of freedom in operation, the troublesomeness will be increased. Thus, it often happens that the conventional image correction apparatus and the like are insufficient in degree of freedom.

### SUMMARY OF THE INVENTION

In view of the foregoing, it is an object of the present invention to provide an image correcting apparatus and an image correcting storage medium storing an image conversion program, which are capable of readily performing the correcting instruction, as mentioned above, with the sufficient degree of freedom.

To achieve the above-mentioned object, the present invention provides a first image correcting apparatus comprising:
an analyzing section that performs a predetermined image analysis for an image to determine a correction value defining an image correction to the image;
a correction alteration section that alters the correction value determined by the analyzing section in accordance with an alteration amount designated by an operation;
an image correction section that applies an image correction to the image to obtain an image having a correction result associated with a correction value altered by the correction alteration section; and
a range set-up section that sets-up a range of an instruction allowable alteration amount to the correction alteration section.

It is acceptable that the “correction value” is a correction amount defining the correction by a difference between conditions before and after the correction, or alternatively a correction target value defining the correction by only the condition after the correction.

Further, it is acceptable that the set-up by the range set-up section is an automatic set-up according to the analysis, or alternatively a manual set-up according to the manual operation.

According to the first image correcting apparatus of the present invention, there is provided the range set-up section as mentioned above. Thus, it is possible to restrict the operating range of the correction alteration to a necessary and sufficient range according to an operator's experience, image analysis and liking. Therefore, according to the first image correcting apparatus of the present invention, it is possible to remove the unnecessary instruction range, and thereby reducing the troublesomeness in operation and securing a sufficient degree of freedom.

In the first image correcting apparatus according to the present invention as mentioned above, it is acceptable that the range set-up section sets-up the range of an instruction allowable alteration amount to an range according to an operation.

In the first image correcting apparatus according to the present invention as mentioned above, it is acceptable that the range set-up section sets-up the range of an instruction allowable alteration amount in accordance with the correction value determined by the analyzing section.

In the first image correcting apparatus according to the present invention as mentioned above, it is acceptable that the range set-up section sets-up the range of an instruction allowable alteration amount to a range according to a result of the image analysis that performed when the analyzing section determines the correction value.

According to the aspect of set-up to the range according to the operation, it is possible to manually set-up the range of the alteration amount to a range according to an operator's experience and liking.

According to the aspect of set-up according to the correction amount or the correction target, it is possible to automatically set-up a range according to the correction result of the automatic correction.

According to the aspect of set-up to a range according to the result of the image analysis, for example, in the event that a plurality of candidates for correction value is obtained by the analysis for the automatic correction, it is possible to find such an application that the first candidate is adopted for the automatic correction, and the alteration range is established in accordance with correction values other than the first candidate.

In the first image correcting apparatus according to the present invention as mentioned above, it is preferable that the analyzing section determines the correction value on a plurality of sorts of image corrections,
in the correction alteration section, the alteration amount is designated on the plurality of sorts of image corrections, and
the range set-up section sets-up the range of an instruction allowable alteration amount to the plurality of sorts of image corrections.

According to the automatic correction based on the image analysis, generally, the various types of image correction as mentioned above are performed. In such various types of image correction, it is desired that alteration ranges suitable for the respective image corrections can be established. When the alteration ranges suitable for the respective image corrections can be established, for example, it is possible to find such an application that the alteration range is set to 0 on the color temperature control since a certain user simply uses only the image under the specific light source.

To achieve the above-mentioned object, the present invention provides a second image correcting apparatus comprising:
an analyzing section that performs a predetermined image analysis for an image to determine correction values each defining a plurality of sorts of image corrections to the image;
a correction alteration section that alters the correction value determined by the analyzing section in accordance with an alteration amount designated by an operation on at least one of the plurality of sorts of image corrections;
an image correction section that applies an image correction to the image to obtain an image having a correction result associated with correction values of the plurality of sorts of image corrections, including the correction value altered by the correction alteration section; and
an alteration sort set-up section that sets-up a sort of an instruction allowable image correction in alteration amount to the correction alteration section.

According to the second image correcting apparatus of the present invention as mentioned above, the alteration sort set-up section sets-up a sort of an instruction allowable image correction in alteration amount in accordance with an operator's experience, image analysis and liking. This feature makes it possible to sufficiently secure a degree of freedom desired for the manual correction and to restrict unnecessary degree of freedom. Therefore, according to the second image correcting apparatus of the present invention, it is possible to readily perform a manual correction instruction with sufficient degree of freedom.

In the second image correcting apparatus according to the present invention as mentioned above, it is preferable that the correction alteration section displays a space defined by a plurality of coordinate axes associated with the image corrections of the sorts set-up by the alteration sort set-up section, and receives an instruction of the alteration amount by means of designating a position on the space by an operation.

In the second image correcting apparatus according to the present invention as mentioned above, it is preferable that the alteration sort set-up section sets-up a plurality of sorts of an instruction allowable image correction in alteration amount to the correction alteration section, and sets-up a single alteration axis capable of designating alteration amounts for the plurality of sorts on a batch basis.

According to the aspect that the space is displayed and the alteration amount is designated at a position on the space, it is possible to intuitively grasp a relation among the various types of image correction by the position on the space, and thereby readily designating the alteration amount.

According to the aspect that the alteration axis for designating the alteration amounts for the plurality of sorts on a batch basis, an establishment of the alteration axis according to an operator's experience, image analysis and liking makes it possible to perform an effective designation.

To achieve the above-mentioned object, the present invention provides a first image correcting program storage medium storing a first image correcting program, which causes a computer to operate as an image correcting apparatus, the image correcting apparatus comprising:
an analyzing section that performs a predetermined image analysis for an image to determine a correction value defining an image correction to the image;
a correction alteration section that alters the correction value determined by the analyzing section or a correction target in accordance with an alteration amount designated by an operation;
an image correction section that applies an image correction to the image to obtain an image having a correction result associated with a correction value altered by the correction alteration section or the correction target; and
a range set-up section that sets-up a range of an instruction allowable alteration amount to the correction alteration section.

According to the first image correcting program storage medium storing the first image correcting program, it is possible to readily implement the structural elements of the first image correcting apparatus by a computer.

To achieve the above-mentioned object, the present invention provides a second image correcting program storage medium storing a second image correcting program, which causes a computer to operate as an image correcting apparatus, the image correcting apparatus comprising:
an analyzing section that performs a predetermined image analysis for an image to determine correction values each defining a plurality of sorts of image corrections to the image;
a correction alteration section that alters the correction value determined by the analyzing section in accordance with an alteration amount designated by an operation on at least one of the plurality of sorts of image corrections;
an image correction section that applies an image correction to the image to obtain an image having a correction result associated with correction values of the plurality of sorts of image corrections, including the correction value altered by the correction alteration section; and
an alteration sort set-up section that sets-up a sort of an instruction allowable image correction in alteration amount to the correction alteration section.

According to the second image correcting program storage medium storing the second image correcting program, it is possible to readily implement the structural elements of the second image correcting apparatus using a computer.

Incidentally, with respect to the first and second image correcting program storage medium storing the first and second image correcting program, there are simply described only the basis aspects. The reason why this is to do so is in order to avoid the redundancy. It is noted that the first and second image correcting program storage medium storing the first and second image correcting program include not only the basis aspects as mentioned above, but also various aspects corresponding to the aspects of the first and second image correcting apparatuses as mentioned above.

### BRIEF DESCRIPTION OF THE DRAWINGS

FIG. 1 is a view useful for understanding an example of a system to which an embodiment of the present invention is applied.

FIG. 2 is a hardware structural view of a computer.

FIG. 3 is a view useful for understanding a first embodiment of an image correcting program stored in an image correcting program storage medium of the present invention.

FIG. 4 is a functional block diagram useful for understanding the first embodiment of an image correcting apparatus of the present invention.

FIG. 5 is a view showing a range set-up screen.

FIG. 6 is a flowchart useful for understanding an operating procedure of an image correcting apparatus of the first embodiment.

FIG. 7 is a view showing an image-correcting screen.

FIG. 8 is an explanatory view useful for understanding a method of computing an instruction allowable range for automatic correction values and a correction alteration.

FIG. 9 is a view useful for understanding a second embodiment of an image correcting program stored in an image correcting program storage medium of the present invention.

FIG. 10 is a functional block diagram useful for understanding the second embodiment of an image correcting apparatus of the present invention.

FIG. 11 is a view showing an alteration axis set-up screen, which is displayed by an alteration axis set-up section.

FIG. 12 is a flowchart useful for understanding an operating procedure of an image correcting apparatus of the second embodiment.

FIG. 13 is a view showing a correcting method setting file.

FIG. 14 is a view showing an image-correcting screen.

FIG. 15 is a view showing another image-correcting screen.

### DETAILED DESCRIPTION OF PREFERRED EMBODIMENTS

Embodiments of the present invention will be described with reference to the accompanying drawings.

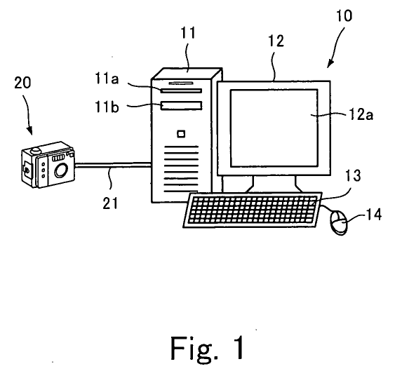

FIG. 1 is a view useful for understanding an example of a system to which an embodiment of the present invention is applied.

According to the example shown in FIG. 1, a digital still camera 20 is connected to a computer 10. Image data, which is obtained through photography by the digital still camera 20, is taken into the computer 10 via a USB cable 21.

According to the example shown in FIG. 1, the computer 10 incorporates therein an embodiment of an image correcting program related to the present invention. When the image correcting program is executed by the computer 10, an embodiment of an image correcting apparatus of the present invention is constructed on the computer 10. On the computer 10, there are constructed functions as various types of processing apparatuses, which utilize image data, as well as the function as the image correcting apparatus.

The image correcting apparatus constructed on the computer 10 applies image correcting processing to the image data received from the digital still camera 20. While an aspect of the embodiment of the present invention resides in the processing operation in the computer 10, first, there will be explained the hardware of the computer 10.

The computer 10 comprises, on an external appearance, a main frame unit 11, an image display unit 12 for displaying an image on a display screen 12a in accordance with an instruction from the main frame unit 12, a keyboard 13 for inputting various sorts of information, and a mouse 14 for inputting an instruction according to, for example, an icon and the like, through designation of an optional position on the display screen 12a, the icon and the like being displayed on the position on the display screen 12a. The main frame unit 11 has, on an external appearance, a flexible disk mounting slot 11a for mounting a flexible disk, and a CD-ROM mounting slot 11b for mounting a CD-ROM.

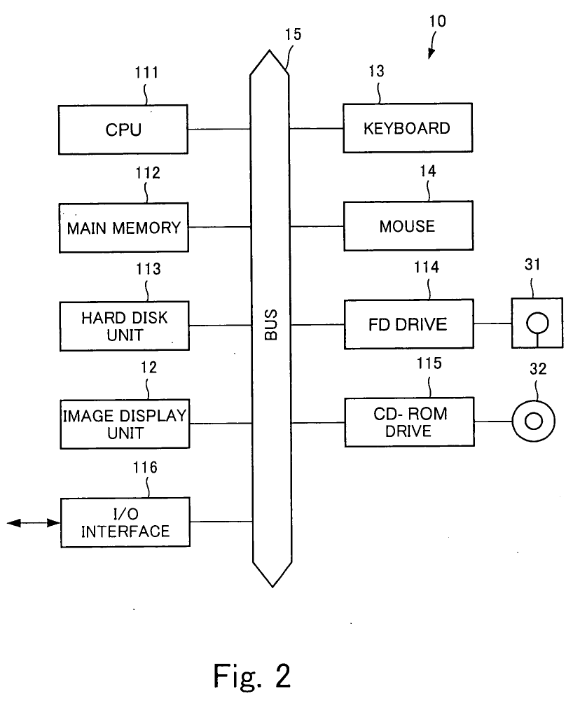

FIG. 2 is a hardware structural view of a computer.

The main frame unit 11 of the computer 10 shown in FIG. 1 comprises a CPU 111 for executing various types of programs, a main memory 112 in which a program stored in a hard disk unit 113 is read and developed for execution by the CPU 111, the hard disk unit 113 that saves various sorts of programs and data, a flexible disk (FD) drive 114 for accessing a flexible disk (FD) 31, a CD-ROM drive 115 for accessing a CD-ROM 32, and an I/O interface 116 connected to the digital still camera 20 (cf. FIG. 1) to receive image data from the digital still camera 20. Those various types of elements, the image display unit 12, the keyboard 13, and the mouse 14, which are also shown in FIG. 1, are connected via a bus 15 to one another.

The CD-ROM 32 stores therein an embodiment of an image correcting program related to the present invention, which causes the computer 10 to operate as an embodiment of an image correcting apparatus of the present invention. The CD-ROM 32 is mounted on the CD-ROM drive 115, so that the image correcting program stored in the CD-ROM 32 is uploaded onto the computer 10 and is stored in the hard disk unit 113.

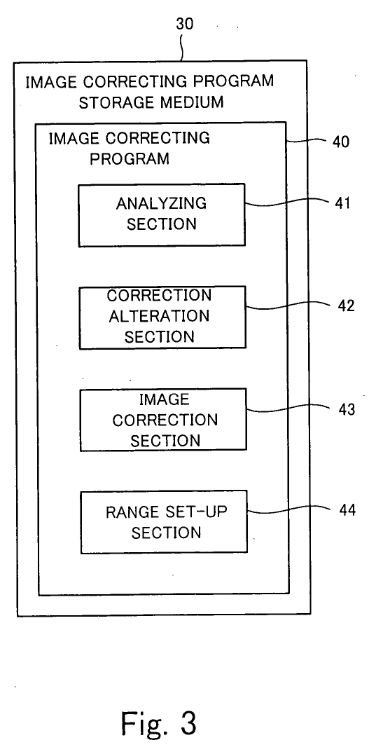

FIG. 3 is a view useful for understanding a first embodiment of an image correcting program stored in an image correcting program storage medium of the present invention.

Any one is acceptable, as storage medium 30 shown in FIG. 3, which is storage medium that stores an image correcting program 40. For example, when a CD-ROM stores the image correcting program 40, the storage medium means the CD-ROM; when a hard disk unit, onto which the image correcting program 40 is loaded, stores the image correcting program 40, the storage medium means the hard disk unit; or when the image correcting program 40 is down-loaded onto a flexible disk, the storage medium means the flexible disk.

The image correcting program 40 is executed in the computer 10 shown in FIG. 1 and causes the computer 10 to operate as an image correcting apparatus that applies a correcting processing to an image. The image correcting program 40 comprises an analyzing section 41, a correction alteration section 42, an image correction section 43, and a range set-up section 44.

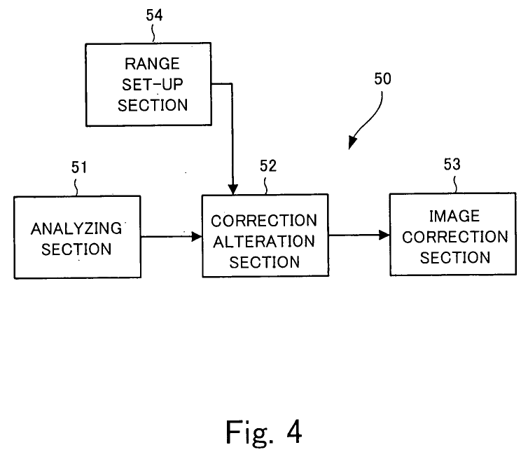

FIG. 4 is a functional block diagram useful for understanding the first embodiment of an image correcting apparatus of the present invention.

An image correcting apparatus 50 is constructed on the computer 10 shown in FIG. 1, when the image correcting program 40 shown in FIG. 3 is installed in the computer 10 and is executed.

The image correcting apparatus 50 comprises an analyzing section 51, a correction alteration section 52, an image correction section 53, and a range set-up section 54. The analyzing section 51, the correction alteration section 52, the image correction section 53, and the range set-up section 54 are constructed on the computer 10 by the analyzing section 41, the correction alteration section 42, the image correction section 43, and the range set-up section 44, respectively, which constitute the image correcting program 40 shown in FIG. 3. While the elements of the image correcting apparatus 50 shown in FIG. 4 correspond to the elements of the image correcting program shown in FIG. 3, respectively, they are different from one another in the following points. The elements of the image correcting apparatus 50 shown in FIG. 4 are constructed by combinations of the hardware of the computer 10 shown in FIG. 1 and OS and application programs to be executed by the computer 10. To the contrary, the elements of the image correcting program shown in FIG. 3 are constructed by only the application programs.

The analyzing section 51, the correction alteration section 52, the image correction section 53, and the range set-up section 54, which are constructed on the computer 10, correspond to the analyzing section, the correction alteration section, the image correction section, and the range set-up section, in the present invention, respectively.

Hereinafter, there will be explained the structural elements of the image correcting apparatus 50 shown in FIG. 4.

The analyzing section 51 analyzes images represented by image data received from the digital still camera 20 shown in FIG. 1 and computes parameters for an automatic image correction. According to the present embodiment, as an example of the image analysis, there are performed analysis of the color temperature (white balance of the light source) and analysis of the brightness (density) so as to determine a correction value of the color temperature and a correction value of the brightness.

The correction alteration section 52 causes the image display unit 12 shown in FIG. 1 and FIG. 2 to display a GUI (Graphical User Interface) operating screen, and receives an instruction of a manual correction via the GUI operating screen.

The image correction section 53 applies image correcting processing to image data in accordance with the correction values determined by the analyzing section 51 and the instruction received by the correction alteration section 52.

The range set-up section 54 sets up an instruction allowable range for a manual correction in the GUI operating screen of the image display unit 12 displayed by the correction alteration section 52. The range set-up section 54 causes the image display unit 12 to display a range set-up screen, and receives on the range set-up screen a manual setting of the range itself and a condition setting to an automatic setting of the range.

Hereinafter, there will be described details of the setting on the range set-up screen and details of the operation of the image correcting apparatus 50.

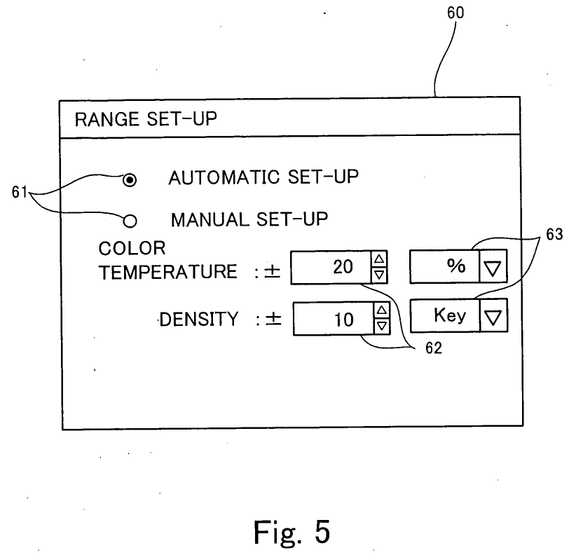

FIG. 5 is a view showing a range set-up screen.

A range set-up screen 60 is provided with radio buttons 61, numerical value set-up columns 62, and unit set-up columns 63.

The radio buttons 61 are for selecting between an automatic set-up mode in which the instruction allowable range of the manual correction is set up automatically and a manual set-up mode in which the instruction allowable range of the manual correction is set up manually. The radio buttons 61 are clicked by the mouse 14 shown in FIG. 1 and FIG. 2. In the event that the radio buttons 61 selects the automatic set-up mode, in order to determine the correcting value in the automatic image correction, the analyzing result by the analyzing section 51 shown in FIG. 4 is used to set up the suitable range as the instruction allowable range for the manual correction. There will be described later details of the automatic set-up mode.

The numerical value set-up columns 62 and the unit set-up columns 63 are effective in the event that the manual set-up mode is selected by the radio buttons 61. Numerical values, which indicate the instruction allowable range for the manual correction, are inputted to the numerical value set-up columns 62. In the unit set-up columns 63, the units associated with the entered numerical values are selected. According to the present embodiment, with respect to the “color temperature”, “degree” and “%” are selectable as the unit, and with respect to the “density”, “Key” and “%” are selectable as the unit. It is noted that the unit “Key” denotes the special unit in which “10” Key is allotted to “1” in density that is generally non-dimensional amount.

In the event that “K” and “Key” are selected in the unit set-up columns 63, the numerical values entered to the numerical value set-up columns 62 represent the absolute values of the instruction allowable range of the manual correction. On the other hand, in the event that “%” is selected as unit in the unit set-up columns 63, the instruction allowable range of the manual correction is set up as the relative range according to the result of the automatic image correction, and thus the numerical values entered to the numerical value set-up columns 62 represent the relative values of the instruction allowable range of the manual correction. For example, in the event that the value after the correction by the automatic image correction to the color temperature is 5750K, and the range of “20%” are set up in the numerical value set-up columns 62 and the unit set-up columns 63, the instruction allowable range of the manual correction is plus or minus 1150K.

In the range set-up section 54 shown in FIG. 4, there is performed the set-up via the range set-up screen 60 as mentioned above, and on the assumption of this set-up, the image correcting apparatus 50 operates as follows.

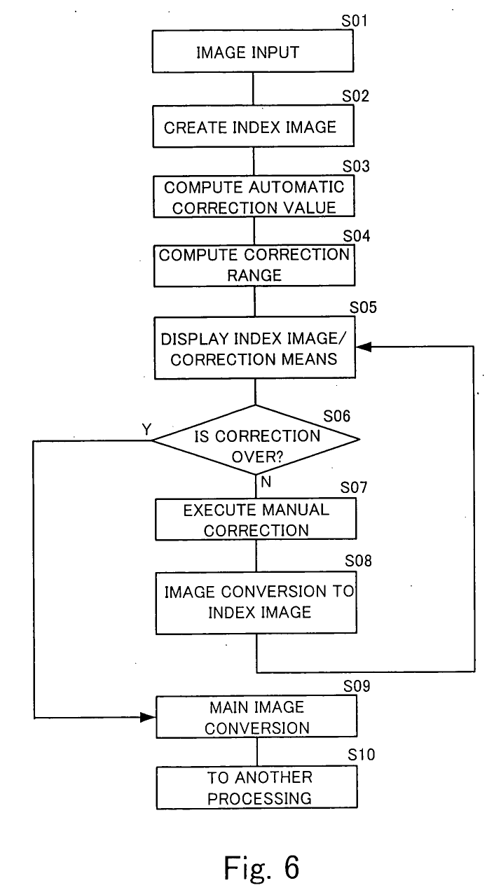

FIG. 6 is a flowchart useful for understanding an operating procedure of an image correcting apparatus of the first embodiment.

The image correcting apparatus 50 receives image data from the digital still camera in the manner as mentioned above (step S01). Then, first, there is created an index image in which an image represented by the image data is reduced (step S02). Next, there is performed analysis of the image represented by the image data to determine a correction value in the automatic image correction (step S03). And there is computed the instruction allowable range of the manual correction to the result of the automatic image correction (step S04). There will be described later a method of computing the correction value and the instruction allowable range.

When the correction value and the instruction allowable range are obtained, there is displayed on the image display unit 12 shown in FIG. 1 and FIG. 2 the image correcting screen for instructing the manual correction through confirmation of the result of the automatic correction by the index image (step S05).

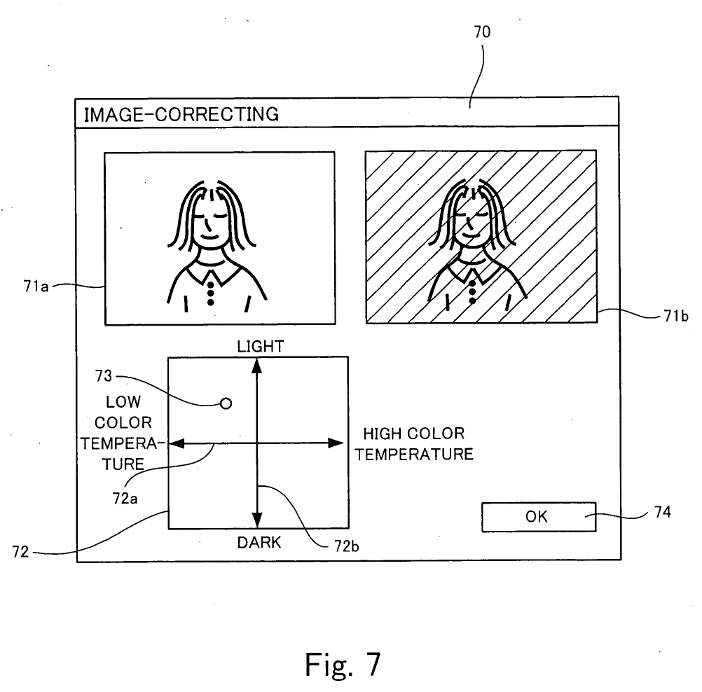

FIG. 7 is a view showing an image-correcting screen.

On an image-correcting screen 70, there are displayed an original index image 71a created in the step S02 of FIG. 6, and a corrected index image 71b in which an image correction is applied to the original index image 71a. Thus, a user of the image correcting apparatus confirms appropriateness of the image correction referring to those index images.

The image-correcting screen 70 is provided with an alteration instruction column 72 for altering the result of the automatic correction and instructing the manual correction. On the alteration instruction column 72, the instruction allowable range for the manual correction is indicated in form of a two-dimensional coordinate space. As two coordinate axes constituting the two-dimensional coordinate space, there are shown an axis 72a of the color temperature and an axis 72b of the brightness. A cross point (origin) of the axis 72a and the axis 72b corresponds to the result of the automatic correction. On the alteration instruction column 72, a pointer 73 is also indicated. When a position of the pointer 73 in the two-dimensional coordinate space is determined in accordance with the operation of the mouse and the like, there is indicated the correction alteration corresponding to the difference between the position of the pointer 73 and the origin.

The image-correcting screen 70 is further provided with an OK button 74. When the OK button 74 is clicked, the end of the manual correction is decided.

Here, there will be explained a method of computing the instruction allowable ranges of the automatic correction values and the correction alteration.

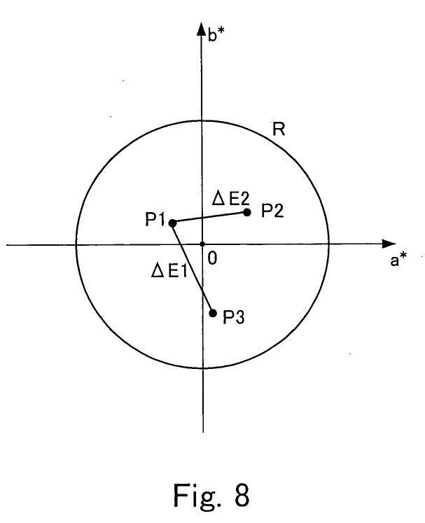

FIG. 8 is an explanatory view useful for understanding a method of computing an instruction allowable range for automatic correction values and a correction alteration.

Here, there will be explained an example of the correction of the color temperature.

When the automatic correction value of the color temperature is determined, first, a gray point of an image is determined by the image analysis, so that a color temperature of a light source in the image is presumed in accordance with the gray point.

FIG. 8 shows a Lab color space on a two-dimensional basis omitting L* axis. In the image analysis, there is analyzed a color distribution existing an area R within a predetermined distance taking as the center an intersection point O of a* axis and b* axis on the Lab color space. For example, with respect to a certain image, when it is assumed that three colors associated with three points P1, P2 and P3, respectively, are included in the image as colors existing in the area R, and areas, in which those colors occupy in the image, are expressed by P1>P3>P2, it is decided that the color associated with the P1 is the grey point in the image. The color associated with the point P1, which is decided as the grey point, is a color of the light source. And in view of the distance between the point P1 and the intersection point O, the color temperature (white balance) of the light source is presumed. When it is assumed that the presumed value of the color temperature is for example 4000K, then there is computed a correction value for correcting a difference from the reference value (e.g. 6500K) which is set beforehand. In order to obtain the suitable white balance, there is computed a correction value for correcting 70% of the difference, retaining an atmosphere of photography by the difference of the light source, but not correcting the difference in its entirety. According to the present embodiment, the automatic correction value of the color temperature is computed as follows.
T1=4000+(6500−4000)×0.7=5750

Where T1 denotes a target value of the correction. Thus, as the color temperature after the automatic correction, there is obtained 5750K.

The instruction allowable range of the manual correction is determined for the correction result corresponding to the thus determined automatic correction value in accordance with the set-up in the range set-up screen 60 shown in FIG. 5 in the manner as set forth below.

In the event that the automatic set-up mode is selected on the range set-up screen 60, there are determined a distance between the point P1 and the point P2 and a distance between the point P1 and the point P3 as shown in FIG. 8. And there is determined a color temperature difference corresponding to those distances. The color temperature difference is used as the width of the instruction allowable range.

On the other hand, in the event that manual set-up mode is selected on the range set-up screen 60, and the range is set to, for example, “20%”, 5750K, which is obtained as the color temperature after the automatic correction, is used, so that width W of the instruction allowable range is computed as follows.
W=5750×0.2=1150
Thus, the range is obtained as plus or minus 1150K.

In the event that manual set-up mode is selected on the range set-up screen 60, and the range is set in unit other than “%”, as a matter of course, regardless of analysis of the image the range is used as set up.

In the step S03 and the step S04 in FIG. 6, the automatic correction value and the correction range are computed in the manner as mentioned above. Then in step SOS, on the image-correcting screen 70 shown in FIG. 7, there are displayed a corrected index image 71b that is subjected to the image correction according to the determined automatic correction value, and an alteration instruction column 72 having a two-dimensional coordinate space representative of the determined correction range. The correction range, which is displayed on the alteration instruction column 72 in form of the two-dimensional coordinate space, is a range that sufficiently secure a degree of freedom for the manual correction. The indication of such a range is useful for taking aim at the suitable manual correction and makes it possible to readily designate the suitable manual correction.

In step S06, when the OK button 74 shown in FIG. 7 is clicked, it is decided as to whether the manual correction is over. When it is decided that the manual correction is not over, an alteration of the correction is instructed by the manual operation on the alteration instruction column 72 (step S07). On the alteration instruction column 72, as mentioned above, when the position of the pointer 73 is decided by the manual operation, the correction alteration is instructed. For example, with respect to the range of plus or minus 1150K that is determined in the manner as mentioned above, in the event that a position of 20% to the minus side is decided, the target value T2 of the manual correction is computed as follows.
T2=5750−1150×0.2=5520
Thus, as the color temperature after the correction alteration by the manual correction, there is obtained 5520K.

In this manner, when the correction alteration is instructed, the alteration is reflected onto the corrected index image 71b in FIG. 7 (step S08), and the process returns to the step S05 to repeat the above-mentioned procedure.

On the other hand, in the step S06, when the OK button 74 shown in FIG. 7 is clicked and it is decided that the manual correction is over, processing for the image correction, which is made in accordance with the correction value finally obtained via the automatic correction and the manual correction, is applied to the image data taken in in the step S01 (step S09). Thus, applying only the processing for the image correction according to the correction value finally obtained to the image data taken in in the step S01 makes it possible to reduce a load of the arithmetic processing that is necessary in the instruction of the manual correction.

The image data subjected to the image correction processing as mentioned above is transferred to another data processing to be executed by the computer 10 in FIG. 1 (step S10).

In this manner, according to the image correcting apparatus of the present embodiment, it is possible to readily perform the correction instruction by the manual operation with the sufficient degree of the freedom.

Incidentally, according to the above-mentioned description, up to the instruction of the manual correction is terminated, the correction is applied to the index image, and after the instruction of the manual correction is completely terminated, the final correction processing is applied to the original image data on a batch basis. However, according to the present invention, it is acceptable that the correction is applied to the original image data whenever a trial instruction in the manual correction is made.

It is noted that as mentioned above, the analysis and the correction of the color temperature and the density are simply one example, and the image analysis and the image correction referred to in the present invention are not restricted to the embodiments. As other image analysis and image correction, it is acceptable that analysis and correction of, for example, chroma saturation and sharpness are adopted.

Next, there will be explained the second embodiment of the present invention.

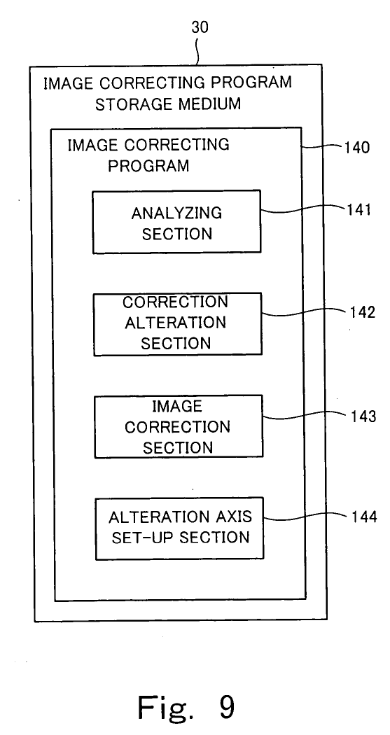

FIG. 9 is a view useful for understanding a second embodiment of an image correcting program stored in an image correcting program storage medium of the present invention.

The image correcting program 140 is executed in the computer 10 shown in FIG. 1 and causes the computer 10 to operate as an image correcting apparatus that applies a correcting processing to an image. The image correcting program 140 comprises an analyzing section 141, a correction alteration section 142, an image correction section 143, and an alteration axis set-up section 144.

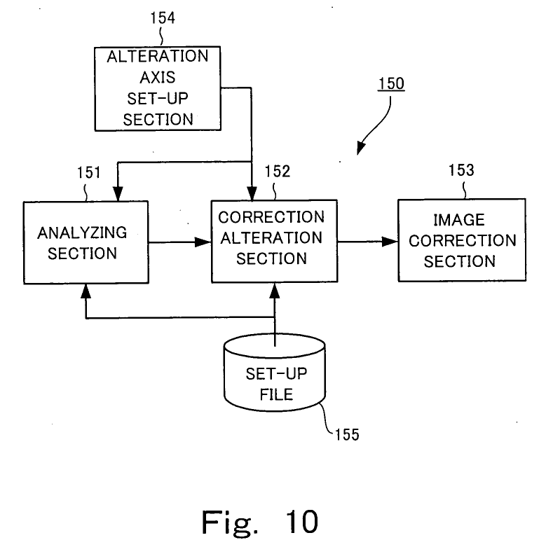

FIG. 10 is a functional block diagram useful for understanding the second embodiment of an image correcting apparatus of the present invention.

An image correcting apparatus 150 is constructed on the computer 10 shown in FIG. 1, when the image correcting program 140 shown in FIG. 9 is installed in the computer 10 and is executed.

The image correcting apparatus 150 comprises an analyzing section 151, a correction alteration section 152, an image correction section 153, and an alteration axis set-up section 154. The analyzing section 151, the correction alteration section 152, the image correction section 153, and the alteration axis set-up section 154 are constructed on the computer 10 by the analyzing section 141, the correction alteration section 142, the image correction section 143, and the alteration axis set-up section 144, respectively, which constitute the image correcting program 140 shown in FIG. 9. While the elements of the image correcting apparatus 150 shown in FIG. 10 correspond to the elements of the image correcting program shown in FIG. 9, respectively, they are different from one another in the following points. The elements of the image correcting apparatus 150 shown in FIG. 9 are constructed by combinations of the hardware of the computer 10 shown in FIG. 1 and OS and application programs to be executed by the computer 10. To the contrary, the elements of the image correcting program shown in FIG. 9 are constructed by only the application programs.

The analyzing section 151, the correction alteration section 152, the image correction section 153, and the alteration axis set-up section 154, which are constructed on the computer 10, correspond to the analyzing section, the correction alteration section, the image correction section, and the alteration axis set-up section, in the present invention, respectively.

Hereinafter, there will be explained the structural elements of the image correcting apparatus 150 shown in FIG. 10.

The analyzing section 151 analyzes images represented by image data received from the digital still camera 20 shown in FIG. 1 and computes parameters for an automatic image correction.

The correction alteration section 152 causes the image display unit 12 shown in FIG. 1 and FIG. 2 to display a GUI (Graphical User Interface) operating screen, and receives an instruction of a manual correction via the GUI operating screen.

The image correction section 153 applies image correcting processing to image data in accordance with the correction values determined by the analyzing section 151 and the instruction received by the correction alteration section 152.

The alteration axis set-up section 154 displays an alteration axis set-up screen. On the alteration axis set-up screen, there is set up a sort of an image correction, which is capable of being instructed in the manual correction by the correction alteration section 152. As will be described, the GUI operating screen, which is displayed by the correction alteration section 152, is provided with an operating lever and the like according to a sort of the image correction set up by the alteration axis set-up section 154. According to the specification, it happens that the sort of the image correction set up by the alteration axis set-up section 154 is expressed by “axis” in meaning that a direction in which a degree of freedom exists.

According to the present embodiment, the set-up of the sort of the image correction in the alteration axis set-up section 154 is also reflected on the analyzing section 151, so that there is computed the correction value on such a sort of image correction. Further, according to the present embodiment, as will be described after, it is possible that the alteration axis set-up section 154 sets up the automatic selection for sorts of the image correction suitable for a sheet type. And in the event that such a set up is established, the analyzing section 151 and the correction alteration section 152 refer to a correction method set-up file 155 in which sorts of the image correction suitable for the sheet types are registered.

Hereinafter, there will be described details of the set-up in the alteration axis set-up section 154 and details of the operation of the image correcting apparatus 150.

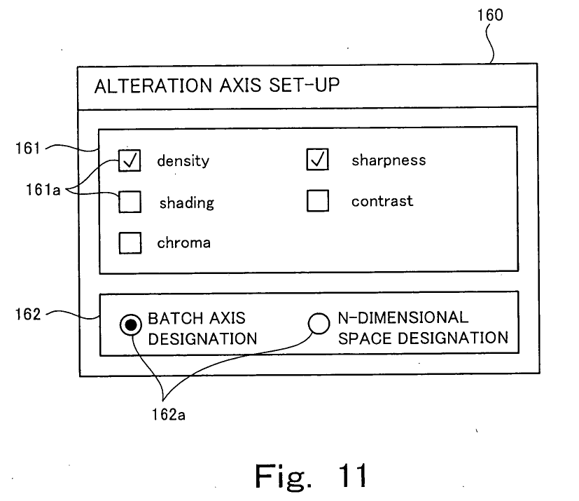

FIG. 11 is a view showing an alteration axis set-up screen, which is displayed by an alteration axis set-up section.

An alteration axis set-up screen 160 is provided with an individual axis selection column 161 and an alteration designation system selection column 162.

The individual axis selection column 161 is provided with five check boxes 161a. Those check boxes 161a are associated with five sorts of image correction such as density, sharpness, shading, contrast, and brightness (chroma). When a user of the image correcting apparatus operates the mouse to check the check boxes 161a, the image correction associated with the checked check boxes 161a is established in form of the axis of the correction alteration in the manual correction.

The alteration designation system selection column 162 is provided with two radio buttons 162a. When the radio buttons 162a are clicked by the mouse operation of the user, a system of designating the manual correction is selected. According to the present embodiment, as a system of designating the manual correction, it is possible to select two systems of a batch axis designation system for designating an alteration using a batch correction axis consisting of a combination of a plurality of sorts of image corrections that is automatically selected in accordance with a scene type, and an N-dimensional space designation system for designating an alteration by means of designating coordinate points on an N-dimensional coordinate space having an axis of the correction alteration set up in the individual axis selection column 161. Incidentally, when the batch axis designation system is selected, the axis of the correction alteration set up in the individual axis selection column 161 is combined with weight of default and is used in form of an alteration axis (a default axis) in a case where a scene type is vague.

The alteration axis set-up section 154 shown in FIG. 10 performs, as mentioned above, a set-up of the correction alteration axis via the alteration axis set-up screen 160. Presupposing this set-up, the image correcting apparatus 150 operates as follows. In the following description, first, there will be explained an operation wherein the batch axis designation system is selected in the alteration designation system selection column 162, and then there will be explained an operation wherein the N-dimensional space designation system is selected.

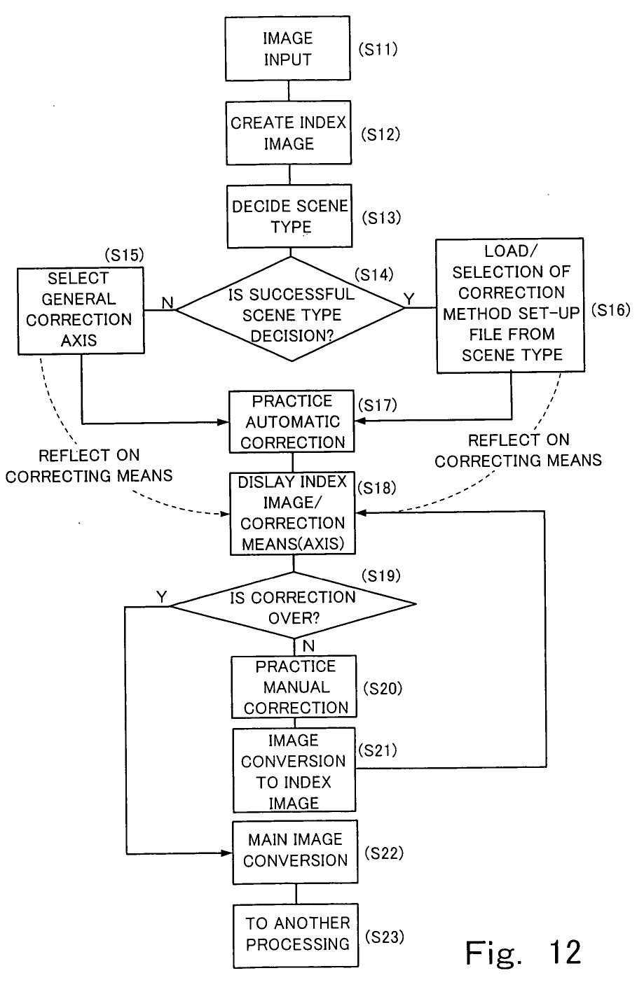

FIG. 12 is a flowchart useful for understanding an operating procedure of an image correcting apparatus of the second embodiment.

The flowchart is useful for understanding an operation of an image correcting apparatus wherein the batch axis designation system is selected.

When the image correcting apparatus receives image data from the digital still camera (step S11) in the manner as mentioned above, first, there is created an index image in which an image represented by the image data is reduced (step S12). Next, the analyzing section performs the scene analysis in accordance with characteristic amount of the image represented by the image data, and it is decided as to which scene type the scene of the image belongs to among a high chroma saturation photograph in which flowers and cars are photographed, a portrait photograph, a night scene, an evening scene, a landscape scene, an underwater photograph, and a tungsten light photograph (step S13). For example, in the event that an area of a person's face is determined as the characteristic amount, by a technique of face detection, which technique is well known in prior art, and the ratio of the area of a person's face to an overall area of the image exceeds a predetermined ratio, it is decided that the image belongs to the “portrait photograph”. However, there exists an image, which is difficult to decide as to which scene type the image belongs to. In this case, such an image is treated as an image that is in failure in decision of the scene type.

In the event that it is in failure in decision of the scene type (step S14: N), as mentioned above, there is selected the default axis in which the axis of the correction alteration set up in the individual axis selection column 161 in FIG. 11 is combined with the weight of the default (step S15). On the other hand, in event that it is successful in decision of the scene type (step S104: Y), the analyzing section refers to the correcting method setting file to select the axis of the image correction suitable for the decided scene type (step S16).

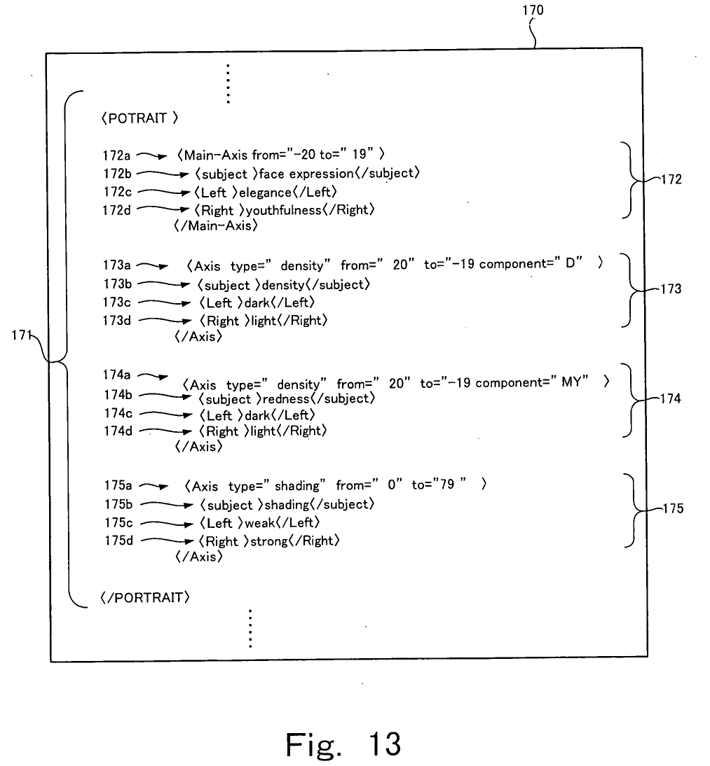

FIG. 13 is a view showing a correcting method setting file.

On a correcting method setting file 170, there is described a definition section 171 that defines axes of image correction for the above-mentioned respective scene types. Here, on behalf of the scene types, there will be explained the definition section 171 that defines an axis as to the scene type addressed as the portrait. The definition section 171 includes a main axis definition section 172 that defines the structure of the batch correction axis, and individual axis definition sections 173, 174 and 175, which define individual correction axes to be combined in form of the batch correction axis.

In the main axis definition section 172, the description of the first line 172a defines that the steps of the batch correction axis are from “−20” to “19”, the description of the second line 172b defines that the axis name is “face expression”, the description of the third line 172c defines that the right side of the axis is a direction increasing “elegance”, and the description of the fourth line 172d defines that the left side of the axis is a direction increasing “youthfulness”. The step “0” in the batch correction axis corresponds to the correction result of the automatic correction.

In the first individual axis definition section 173, the description of the first line 173a defines that the alteration allowable range is concerned from “20” Key to “−19” Key on an axis in which the first axis alters density of “D” of C (cyan), M (magenta), Y (yellow), and D (black). Where the unit “Key” is an especial unit in which “10” Key is allotted to “1” in density that is generally non-dimensional amount. The description of the second line 173b defines that the axis name is concerned with the “density”. The description of the third line 173c defines that the right side of the axis is concerned with a direction increasing “dark”. The description of the fourth line 173d defines that the left side of the axis is concerned with a direction increasing “light”.

In the second individual axis definition section 174, the description of the first line 174a defines that the step is concerned from “20” Key to “−19” Key on an axis in which the second axis alters density of “M” and “Y” of C (cyan), M (magenta), Y (yellow), and D (black). The description of the second line 174b defines that the axis name is concerned with the “redness”. The description of the third line 174c defines that the right side of the axis is concerned with a direction increasing “dark”. The description of the fourth line 173d defines that the left side of the axis is concerned with a direction increasing “light”.

In the third individual axis definition section 175, the description of the first line 175a defines that the step is concerned from “0” shading to “79” shading on an axis in which the third axis alters “shading”. The description of the second line 175b defines that the axis name is concerned with the “Shading”. The description of the third line 175c defines that the right side of the axis is concerned with a direction increasing “weak”. The description of the fourth line 175d defines that the left side of the axis is concerned with a direction increasing “strong”.

According to the definitions as mentioned above, an alteration of the batch correction axis “face expression” by +1 causes “density”=“D”, “redness”=and “Y”, and “Shading” to alter by −1 Key, −1 Key, and +2 shading, respectively, on a batch basis. In other words, the use of the batch correction axis makes it possible to obtain the correction values for a plurality of sorts of image correction on a batch basis.

In step S16 in FIG. 12, the correcting method setting file 170 is referred to, and the batch correction axis, which is defined in accordance with the scene type, is defined. Thereafter, there are computed the correction value associated with the batch correction axis or the above-mentioned default axis, and the automatic image correction according to the correction value is applied to the index image (step S17).

Thereafter, on the image display unit 12 shown in FIG. 1 and FIG. 2, there is displayed image correction screen for instructing the manual correction through confirming the result of the automatic correction with the index image (step S18). At that time, the axis, which is selected in the step S15 or the step S16, is reflected on the image correction screen.

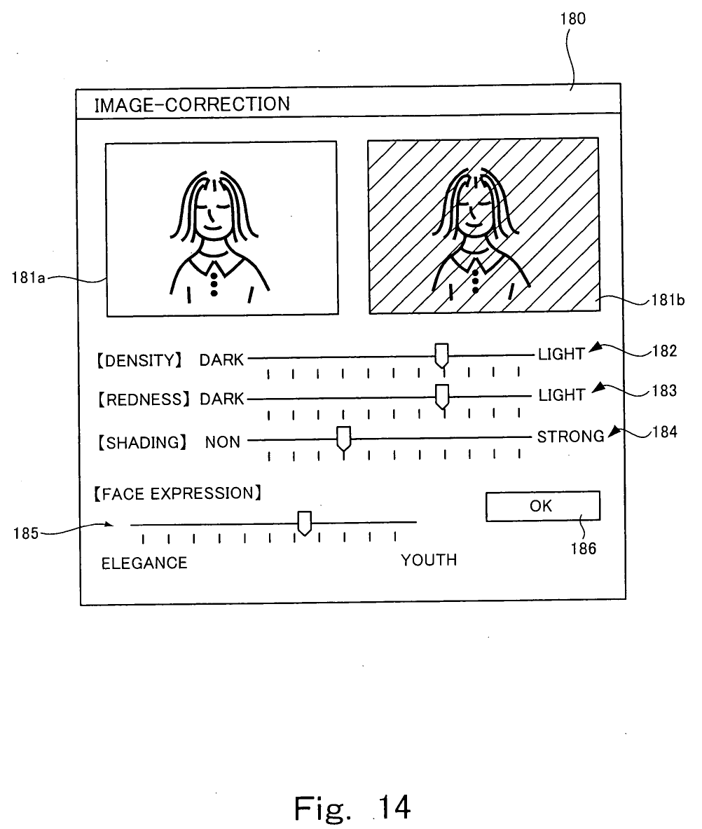

FIG. 14 is a view showing an image-correcting screen.

On an image-correcting screen 180, there are displayed an original index image 181a created in the step S12 of FIG. 12, and a corrected index image 181b in which an image correction is applied to the original index image 181a. Thus, a user of the image correcting apparatus confirms appropriateness of the image correction referring to those index images.

The image-correcting screen 180 is provided with a batch correction axis 185 as means for instructing the manual correction through alteration of the result of the automatic correction. The image-correcting screen 180 is further provided with individual correction axes 182, 183 and 184 for indicating contents of the manual correction by the batch correction axis 185. A use of the image correcting apparatus moves a lever of a batch correction axis 185 to instruct the correction alteration by the manual correction. When such an instructing operation is performed, levers of the individual correction axes 182, 183 and 184 move by the respective migration length associated with the migration length of the lever of the batch correction axis 185. In this manner, a user's operation for the batch correction axis 185 makes it possible to readily instruct the correction value on a combination of a plurality of sorts of image corrections suitable for the scene type. As to the combination of image corrections suitable for the scene type, according to the present embodiment, it has been already established in the correction method set-up file, and it is impossible to alter the combination. However, a sufficiently strict decision of the scene type ensures a sufficient correction. A preparation of various sorts of variation of scene types ensures a degree of freedom. With respect to images, which can not be classified in the scene type, it is possible to suitably set up the default axis on the alteration axis set-up screen shown in FIG. 11. Thus, it is possible to select an arbitrary correction in accordance with user's taste or experience. In this manner, the correction instruction by the batch correction axis and the default axis has a sufficient degree of freedom and is easy.

At the lower right of the image-correcting screen 180, there is provided an OK button 186. When the OK button 186 is clicked, it is decided that the manual correction is over.

In step S19 of FIG. 12, when the OK button 186 is clicked, it is decided as to whether the manual correction is over. In the event that it is decided that the manual correction is not over, the alteration of the correction is instructed manually through the batch correction axis 185 of FIG. 14 (step S20).

In this manner, when the correction alteration is instructed, the alteration, that is, the correction values indicated by the respective individual correction axes 182, 183 and 184, are reflected on a correction index image 181b in FIG. 14 (step S21), and the process returns to the step S18 to repeat the above-mentioned procedures.

On the other hand, in the step S19, in the event that the OK button 186 shown in FIG. 14 is clicked and it is decided that the manual correction is over, image correcting processing is applied to the image data received in the step S11 in accordance with the correction values finally obtained via the automatic correction and the manual correction (step S19). In this manner, with respect to the image data received in the step S11, an application of only the image correction processing according to the finally obtained correction values to the image data makes it possible to reduce a load of the arithmetic processing which will be needed in instruction of the manual correction.

The image data thus subjected to the image correction processing is transferred to another data processing to be executed in the computer 10 in FIG. 1 (step S20).

Thus, according to the image correcting apparatus of the present embodiment, it is possible to readily perform the correction instruction by the manual operation with a sufficient degree of freedom.

Next, there will be explained an operation of the image correcting apparatus 150 in FIG. 10 in which the N-dimensional space designation system is selected on the alteration axis set-up screen shown in FIG. 11. In this case, the operation of the image correcting apparatus 150 is greatly different from the operation shown in the flowchart of FIG. 12 in step S13 to step S16, and slightly different in step S18, but identical in other portion. Thus, in order to avoid the redundant explanation, hereinafter, there will be explained only the different points.

In this case, after the index image is created in the step S12 of FIG. 12, the analyzing section performs an image analysis associated with the axes set up in the individual axis selection column 161 in FIG. 11, and a computation for the correction values for the image correction associated with the axes. In the step S17 of FIG. 12, the automatic image correction according to the correction values is applied to the index image.

Thereafter, in order to instruct the manual correction through confirmation of the result of the automatic correction with the index image, an image-correcting screen, which is different from the image-correcting screen 180 shown in FIG. 14, is displayed on the image display unit 12 shown in FIG. 1 and FIG. 2 (step S18 in FIG. 12). On this image-correcting screen, there is displayed the N-dimensional coordinate space having the axes set up in the individual axis selection column 161 in FIG. 11

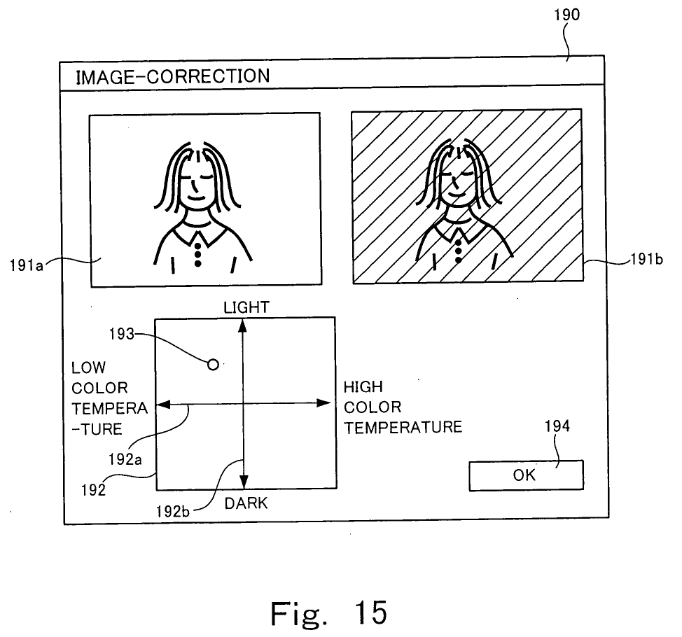

FIG. 15 is a view showing another image-correcting screen.

On an image-correcting screen 190, there are displayed an original index image 191a created in the step S12 of FIG. 12, and a corrected index image 191b in which an image correction is applied to the original index image 191a. Thus, a user of the image correcting apparatus confirms appropriateness of the image correction referring to those index images.

The image-correcting screen 190 is provided with an alteration instruction column 192 for altering the result of the automatic correction and instructing the manual correction. On the alteration instruction column 192, the instruction allowable range for the manual correction is indicated in form of an N-dimensional coordinate space (here, for example, a two-dimensional coordinate space). As the coordinate axes constituting the N-dimensional coordinate space, there are shown the axes set up on the individual axis selection column 161 in FIG. 11, for example, an axis 192a of the color temperature and an axis 192b of the brightness. A cross point (origin) of the axis 192a and the axis 192b corresponds to the result of the automatic correction. On the alteration instruction column 192, a pointer 193 is also indicated. When a position of the pointer 193 in the N-dimensional coordinate space is determined in accordance with the operation of the mouse and the like, there is indicated the correction alteration corresponding to the difference between the position of the pointer 193 and the origin.

The image-correcting screen 190 is further provided with an OK button 194. When the OK button 194 is clicked, it is decided that the manual correction is over.

In the event that the image-correcting screen 190 is displayed, when a user sets up an axis, which is necessary and sufficient for a degree of freedom of the correction, it is possible to display on the alteration instruction column 192 the N-dimensional coordinate space having the necessary and sufficient coordinate axis, so that the user can instruct the correction alteration on the N-dimensional coordinate space with the sufficient degree of freedom, while the user readily grasps the mutual relation between the axes.

According to the present embodiment, on the image correcting-screen of FIG. 14, there is provided the individual correction axis constituting the batch correction axis as well as the batch correction axis. However, according to the present invention, it is acceptable that there is provided only the batch correction axis.

Further, according to the present embodiment, there is disclosed an example in which the batch correction axis is automatically set up in accordance with the image analysis and the N-dimensional coordinate space is selected by the user's operation. However, according to the present invention, it is acceptable that the batch correction axis is selected by the user's operation and the N-dimensional coordinate space is automatically set up in accordance with the image analysis.

According to the present invention, it is possible to readily perform the correcting instruction with the sufficient degree of freedom.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

1. An image correcting apparatus comprising:
an analyzing section that performs a predetermined image analysis for an image to determine a correction value defining an image correction to the image;
a correction alteration section that alters the correction value determined by the analyzing section in accordance with an alteration amount designated by an operation;
an image correction section that applies an image correction to the image to obtain an image having a correction result associated with a correction value altered by the correction alteration section; and
a range set-up section that sets-up a range of an instruction allowable alteration amount to the correction alteration section.

2. An image correcting apparatus according to claim 1, wherein the range set-up section sets-up the range of an instruction allowable alteration amount to an range according to an operation.

3. An image correcting apparatus according to claim 1, wherein the range set-up section sets-up the range of an instruction allowable alteration amount in accordance with the correction value determined by the analyzing section.

4. An image correcting apparatus according to claim 1, wherein the range set-up section sets-up the range of an instruction allowable alteration amount to a range according to a result of the image analysis that performed when the analyzing section determines the correction value.

5. An image correcting apparatus according to claim 1, wherein the analyzing section determines the correction value on a plurality of sorts of image corrections,
in the correction alteration section, the alteration amount is designated on the plurality of sorts of image corrections, and
the range set-up section sets-up the range of an instruction allowable alteration amount to the plurality of sorts of image corrections.

6. An image correcting apparatus comprising:
an analyzing section that performs a predetermined image analysis for an image to determine correction values each defining a plurality of sorts of image corrections to the image;
a correction alteration section that alters the correction value determined by the analyzing section in accordance with an alteration amount designated by an operation on at least one of the plurality of sorts of image corrections;
an image correction section that applies an image correction to the image to obtain an image having a correction result associated with correction values of the plurality of sorts of image corrections, including the correction value altered by the correction alteration section; and
an alteration sort set-up section that sets-up a sort of an instruction allowable image correction in alteration amount to the correction alteration section.

7. An image correcting apparatus according to claim 6, wherein the correction alteration section displays a space defined by a plurality of coordinate axes associated with the image corrections of the sorts set-up by the alteration sort set-up section, and receives an instruction of the alteration amount by means of designating a position on the space by an operation.

8. An image correcting apparatus according to claim 6, wherein the alteration sort set-up section sets-up a plurality of sorts of an instruction allowable image correction in alteration amount to the correction alteration section, and sets-up a single alteration axis capable of designating alteration amounts for the plurality of sorts on a batch basis.

9. An image correcting program storage medium storing an image correcting program, which causes a computer to operate as an image correcting apparatus, the image correcting apparatus comprising:
an analyzing section that performs a predetermined image analysis for an image to determine a correction value defining an image correction to the image;
a correction alteration section that alters the correction value determined by the analyzing section or a correction target in accordance with an alteration amount designated by an operation;
an image correction section that applies an image correction to the image to obtain an image having a correction result associated with a correction value altered by the correction alteration section or the correction target; and
a range set-up section that sets-up a range of an instruction allowable alteration amount to the correction alteration section.

10. An image correcting program storage medium storing an image correcting program, which causes a computer to operate as an image correcting apparatus, the image correcting apparatus comprising:
an analyzing section that performs a predetermined image analysis for an image to determine correction values each defining a plurality of sorts of image corrections to the image;
a correction alteration section that alters the correction value determined by the analyzing section in accordance with an alteration amount designated by an operation on at least one of the plurality of sorts of image corrections;
an image correction section that applies an image correction to the image to obtain an image having a correction result associated with correction values of the plurality of sorts of image corrections, including the correction value altered by the correction alteration section; and
an alteration sort set-up section that sets-up a sort of an instruction allowable image correction in alteration amount to the correction alteration section.
